(19) United States
(12) Patent Application Publication
(10) Pub. No.: US 2024/0046270 A1
(43) Pub. Date: Feb. 8, 2024

(54) INTELLIGENT DECISIONING AND ROUTING FOR REQUESTS RELATED TO AUTOMATED EVENTS

(71) Applicant: Capital One Services, LLC, McLean, VA (US)

(72) Inventors: Tyler MAIMAN, Melville, NY (US); Joshua EDWARDS, Philadelphia, PA (US)

(21) Appl. No.: 17/818,069

(22) Filed: Aug. 8, 2022

(51) Int. Cl. G06Q 20/40; G06Q 20/22; G06N 20/00

(52) U.S. Cl. CPC G06Q 20/4014; G06Q 20/405; G06Q 20/227; G06N 20/00

(57) ABSTRACT

In some implementations, a system may receive an automatic transaction request associated with an amount. The system may determine that transferring the amount associated with the automatic transaction request from a main account would cause a value associated with the main account to fail to satisfy a threshold. The system may generate an alternative transaction processing instruction to prevent the automatic transaction request from causing the value associated with the main account to fail to satisfy the threshold. The system may process the automatic transaction request according to the alternative transaction processing instruction, wherein processing the automatic transaction request includes: processing the automatic transaction request using one or more alternative accounts or using the main account after the value of the main account has changed to a level sufficient to satisfy the threshold and cover the amount associated with the automatic transaction request.

### BACKGROUND

An automatic payment is an arrangement with a creditor (e.g., a lender, a merchant, or the like) that allows the creditor to withdraw money from a checking or savings account or charge money to a credit card in order to pay a bill. For example, an automatic payment may be used to make recurring payments (e.g., on a monthly or periodic basis) for a mortgage, rent, a utility bill, an automobile loan or lease, or a gym membership, among other examples. Automatic payments differ from recurring bill pay features offered by banks and credit card companies. For example, in a recurring bill pay service, a user typically provides a bank or a credit card company permission or an instruction to send payments to a creditor. On the other hand, with in an automatic payment, the user authorizes a creditor to withdraw payments from a bank account and/or charge payments to a credit card account.

### SUMMARY

Some implementations described herein relate to a system for intelligent decisioning and routing for automatic transaction requests. The system may include one or more memories and one or more processors communicatively coupled to the one or more memories. The one or more processors may be configured to receive, from a user device, information to identify one or more alternative accounts to be used in one or more automatic transactions to prevent a value associated with a main account from failing to satisfy a threshold. The one or more processors may be configured to receive multiple automatic transaction requests that are each associated with a respective amount to be transferred from the value associated with the main account. The one or more processors may be configured to determine that transferring an aggregate amount associated with the multiple automatic transaction requests from the main account would cause the value associated with the main account to fail to satisfy the threshold. The one or more processors may be configured to process a first automatic transaction request, included among the multiple automatic transaction requests, using the main account. The one or more processors may be configured to process a second automatic transaction request, included among the multiple automatic transaction requests, using the one or more alternative accounts or using the main account after the value of the main account has changed to a level that is sufficient to satisfy the threshold and to cover the respective amount associated with the second automatic transaction request.

Some implementations described herein relate to a method for intelligent processing of automatic transaction requests. The method may include receiving, by a system, an automatic transaction request associated with an amount to be transferred from a value associated with a main account. The method may include determining, by the system, that transferring the amount associated with the automatic transaction request from the main account would cause the value associated with the main account to fail to satisfy a threshold. The method may include generating, by the system, an alternative transaction processing instruction to prevent the automatic transaction request from causing the value associated with the main account to fail to satisfy the threshold. The method may include processing, by the system, the automatic transaction request according to the alternative transaction processing instruction, wherein processing the automatic transaction request includes, processing the automatic transaction request using one or more alternative accounts, or processing the automatic transaction request using the main account after the value of the main account has changed to a level that is sufficient to satisfy the threshold and to cover the amount associated with the automatic transaction request.

Some implementations described herein relate to a non-transitory computer-readable medium that stores a set of instructions for a system. The set of instructions, when executed by one or more processors of the system, may cause the system to receive multiple automatic transaction requests that are each associated with a respective amount to be transferred from a value associated with a main account. The set of instructions, when executed by one or more processors of the system, may cause the system to determine that transferring an aggregate amount associated with the multiple automatic transaction requests from the main account would cause the value associated with the main account to fail to satisfy a threshold. The set of instructions, when executed by one or more processors of the system, may cause the system to generate a first instruction to process a first set of automatic transaction requests, included among the multiple automatic transaction requests, using the main account. The set of instructions, when executed by one or more processors of the system, may cause the system to generate a second instruction to process a second set of automatic transaction requests, included among the multiple automatic transaction requests, using one or more alternative accounts. The set of instructions, when executed by one or more processors of the system, may cause the system to generate a third instruction to delay processing a third set of automatic transaction requests, included among the multiple automatic transaction requests, until the value of the main account has changed to a level that is sufficient to satisfy the threshold and to cover the respective amounts associated with the third set of automatic transaction requests.

### BRIEF DESCRIPTION OF THE DRAWINGS

FIG. 1 is a diagram of an example implementation associated with intelligent decisioning and routing for requests related to automated events, in accordance with some embodiments of the present disclosure.

FIG. 2 is a diagram of training and using a machine learning model in connection with intelligent decisioning and routing for requests related to automated events, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process associated with intelligent decisioning and routing for requests related to automated events, in accordance with some embodiments of the present disclosure.

### DETAILED DESCRIPTION

The following detailed description of example implementations refers to the accompanying drawings. The same reference numbers in different drawings may identify the same or similar elements.

In an automatic payment arrangement, a consumer authorizes a creditor to withdraw money from a bank account and/or charge money to a credit card account in order to pay a bill. For example, many creditors may allow a customer to register for automatic payments through a website, in which case the customer logs into the creditor website, link a main account from which to debit funds (e.g., in the case of a linked bank account) or charge payments (e.g., in the case of a linked credit card account), and/or agree to any other payment terms and/or conditions (e.g., a date on which to debit or charge payments). Creditors that offer automatic payment services may include lenders (e.g., mortgage lenders or mortgage servicers, automobile lenders, and/or student loan lenders), merchants (e.g., providers of goods and/or services, such as streaming services, gym memberships, and/or childcare services), and/or other service providers (e.g., utility companies, landlords or property management companies that collect rent, and/or credit card companies). Automatic payments offer various benefits, including an ability to avoid late payments, reduce the time and/or computing resources that would otherwise be incurred generating and paying bills, save money on postage and/or reduce the burden on postal services to deliver bills and/or bill payments, and/or reduced a fraud risk by conducting automating payments through secure websites and/or communication channels.

However, automatic payments also carry certain risks, such as a potential to incur overdraft fees and/or fail to make a payment on time due to insufficient funds or exceeding a credit limit. For example, customers often link multiple automatic payments to the same main account (e.g., a checking account, a savings account, or a credit card account), which creates a risk that the available balance in the linked account may be too low to cover an automatic payment expense. In such cases, the creditor may charge a fee to the customer for a returned or declined payment, a financial institution where the main account is held may charge an overdraft fee or other fee (e.g., for dropping below a minimum balance) to the customer, and/or the customer may be subject to other penalties for a missed payment (e.g., a suspension of service). In such cases, where one or more automatic payments fail due to a charged amount exceeding available funds and/or an available credit limit in the linked account, computing resources may be consumed in connection with the creditor using one or more devices and/or resources to discontinue one or more services associated with the failed automatic payment(s) (e.g., using utility lines and/or other resources to suspend delivery of electricity, water, or other utilities to the consumer's residence, using computing resources to suspend the consumer's streaming service and/or send communications to the consumer to indicate that the streaming service has been suspended, or the like). In other examples, a failed automatic payment may increase usage of computing resources due to the creditor and/or the financial institution using the computing resources to charge fees to and/or collect fees from the customer and/or due to the consumer using the computing resources to configure a new payment method, pay overdraft and/or returned payment fees, call a service provider to reinstate service, or the like.

In some implementations, an automatic payment system may enable a user of a user device to designate one or more alternative accounts to use in an automatic payment in cases where a batch of automatic payments (e.g., one or more automatic payments that are received within a particular time period and/or are scheduled to be charged to a linked account within a particular time period) are linked to a main account with an available balance that is insufficient to cover all the automatic payments in the batch. For example, the automatic payments may be linked to a bank account (e.g., a debit, checking, or savings account) from which funds are withdrawn or otherwise deducted (e.g., via automated clearing house (ACH) transfer) or to a credit card account to which amounts due are charged. In some cases, one or more automatic payments may be eligible to be made from bank accounts only, from bank accounts or credit card accounts (e.g., with or without a credit card processing fee), or the like. In either case, the user may interact with the automatic payment system via the user device to designate the one or more alternative accounts, which may include an alternative bank account or an alternative credit card account to use in an automatic payment that would otherwise result in the available balance in the linked account failing to satisfy a threshold (e.g., causing an available balance in a bank account to fall below zero, a minimum balance, or another threshold or causing an outstanding balance on a credit card account exceeding a credit limit or another threshold). Accordingly, in cases where the automatic payment system receives one or more automatic payment requests, the automatic payment system may generate an approval decision and/or redirect one or more automatic payment requests to avoid a potential overdraft condition or other payment failure (e.g., a declined credit card authorization) when the main account linked to an automatic payment lacks sufficient funds and/or available credit to cover the automatic payment. For example, when one or more automatic payment requests are received and there are insufficient funds and/or available credit to cover all the payment requests, the automatic payment system may determine which automatic payments are eligible to be delayed until more funds are available and/or redirected to an alternative funding source, such as a virtual card number (VCN) linked to a credit card account. In cases where there are multiple alternative funding sources and/or multiple automatic payment requests that are eligible to be delayed and/or redirected, the automatic payment system may further use machine learning techniques to select the best alternative funding source and/or prioritize the automatic payment requests (e.g., approve a critical payment such as a utility bill from the main account, and redirect or hold low-priority payments such as streaming service bills).

In this way, in addition to reducing a risk that a consumer will incur an overdraft fee, a returned payment fee, suspended service, or other consequences associated with a missed payment, the automatic payment system may conserve computing resources that would otherwise be incurred by one or more devices and/or resources being used to discontinue one or more services associated with the failed automatic payment(s). Furthermore, preventing automatic payment failures may conserve resources associated with devices operated by the creditor and/or the financial institution where the main account is held by avoiding a need to use computing resources to charge fees to and/or collect fees from the customer, communicate with the customer to notify the customer about the failed payment and/or the need to update an automatic payment method, or the like. Furthermore, preventing automatic payment failures may conserve resources associated with the user device operated by the consumer by avoiding a need to access and communicate with the website(s) of the creditor(s) to update the automatic payment method, communicate over telephone lines to reconnect disrupted services, pay overdraft and/or returned payment fees, or the like.

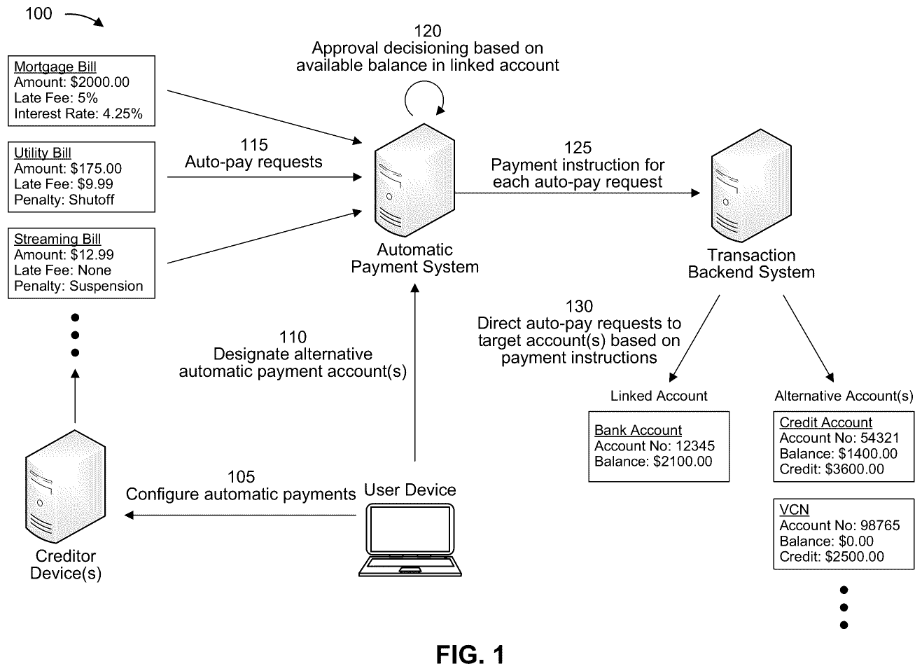

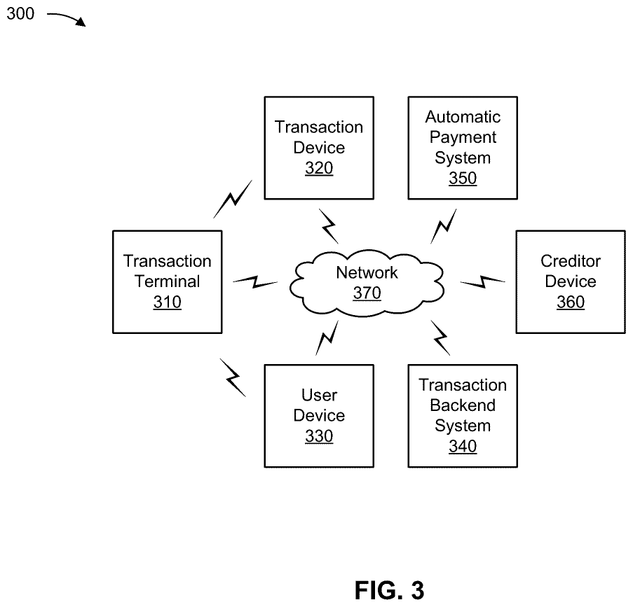

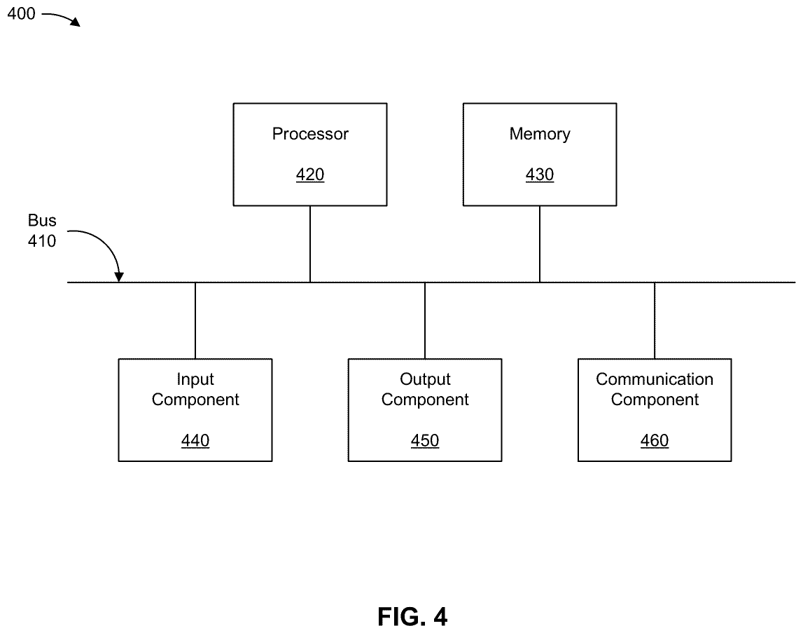

FIG. 1 is a diagram of an example 100 associated with intelligent decisioning and routing for requests related to automated events. As shown in FIG. 1, example 100 includes a user device, a creditor device, an automatic payment system, and a transaction backend system. The user device, the automatic payment system, and the transaction backend system devices are described in more detail in connection with FIG. 3 and FIG. 4.

As shown in FIG. 1, and by reference number 105, a user of the user device may interact with one or more creditor devices to configure automatic payments. For example, some implementations are described herein in connection with the user linking multiple automatic payments to the same main account, which may be referred to herein as “the linked account” for clarity and/or brevity. However, it will be appreciated that the user of the user device may configure automatic payments with various creditors (e.g., lenders, service providers, utility companies, or the like), and that the automatic payments may include different subsets that are linked to different main accounts (e.g., one or more automatic payments may be configured to be deducted from a bank account, one or more automatic payments may be configured to be deducted from a credit card account, one or more automatic payments may be configured to be deducted from a different bank account or credit card account, and/or any suitable combination thereof). In some implementations, in order to configure the automatic payments, the user may interact with the user device to access a website or other portal (e.g., a mobile application) that allows the user to input information associated with a bank account or credit card account to be used in the automatic payment, provide the creditor with permission or authorization to electronically withdraw or charge money to the linked account (e.g., on a recurring or regular basis, such as monthly or annually, or when other conditions are satisfied, such as an available balance falling below an auto-reload threshold). Furthermore, the user may interact with the creditor device to agree to any terms and/or conditions associated with the automatic payment (e.g., an agreement to pay a fee if an automatic payment fails and/or a date on which to schedule the automatic payment, among other examples).

For example, FIG. 1 illustrates an example in which the user configures various bills to be paid from a linked bank account, which may be a debit, checking, savings, or other suitable account that permits an ACH funds transfer. In the illustrated example, the user has configured automatic payments in which a mortgage bill, a utility bill, a streaming service bill, and/or other bills are electronically paid from the linked bank account. It will be appreciated that the automatic payments shown in FIG. 1 are examples only, and that many types of automatic payments may be configured (e.g., for gym memberships, childcare services, rent, automatic toll transponders, merchant-specific loyalty cards, tuition, and/or automobile loans or leases, among other examples). Furthermore, in some cases, the user may configure automatic payments with different creditors for the same or similar types of accounts (e.g., different streaming services, different utility companies, or the like). Furthermore, although FIG. 1 depicts an example in which the automatic payments are linked to a bank account, it will be appreciated that some automatic payments may be linked to a credit card account and/or an automatic payment may be configured in which a credit card account is paid from a bank account, among other examples. Furthermore, in some cases, an automatic payment may be eligible for payment from a bank account only or an automatic payment may be eligible for payment from a bank account or a credit card account. Additionally, or alternatively, a creditor may offer a discount or a reduced interest rate when an automatic payment is linked to a certain account type (e.g., a bank account for ACH transfer) and/or may charge a fee or a higher interest rate when an automatic payment is linked to a certain account type (e.g., a credit card account). Accordingly, automatic payments may be linked to certain account types, configured in various ways, with varying terms and conditions, or the like, and the automatic payment system may evaluate these and/or other factors when determining how to route or otherwise process automatic payment requests.

As further shown in FIG. 1, and by reference number 110, the user may interact with the user device to communicate with the automatic payment system and designate one or more alternative accounts to be used in an automatic payment when one or more conditions are satisfied. For example, in cases where a main account linked to one or more automatic payments is a bank account (e.g., a debit, checking, or savings account supporting an ACH funds transfer), the user may be subject to an overdraft fee if the available balance in the bank account falls below zero (e.g., subject to any overdraft protection that may be enabled on the bank account). Additionally, or alternatively, the bank account may be associated with other fees that arise if the available balance fails to satisfy a threshold (e.g., the bank account may be associated with a monthly service fee that is waived only if the available balance does not fall below a minimum daily balance within a statement period) and/or the user may configure a minimum balance threshold to ensure that a minimum amount of funds are always available in the bank account. In other examples, in cases where the main account linked to one or more automatic payments is a credit card account, a requested automatic payment may be declined if the automatic payment would cause an outstanding balance on the credit card account to exceed a credit limit and/or the user may configure a maximum balance on the credit card account to avoid falling into credit card debt. Accordingly, the user may designate the one or more alternative accounts such that the one or more alternative accounts may be used in an automatic payment that would otherwise cause the available balance of the linked account to fail to satisfy (e.g., equal or exceed) a threshold (e.g., causing an overdraft or causing a credit limit to be exceeded).

For example, in some implementations, the user may designate one or more alternative bank accounts (e.g., a secondary or backup bank account) and/or one or more credit card accounts that may be used in an automatic payment that would otherwise cause the available balance of the linked account to fail to satisfy the applicable threshold. Additionally, or alternatively, the user may indicate that a VCN is to be generated and used in an automatic payment that would otherwise cause the available balance of the linked account to fail to satisfy the applicable threshold. For example, a VCN, sometimes referred to as a virtual credential, a virtual payment credential, and/or a virtual credit card, is a computer-generated version of a primary payment credential (e.g., a credit card number) that may be linked to the primary payment credential and used as a substitute for the primary payment credential in a transaction. For example, a financial institution may issue a transaction card (e.g., a credit card) to a person, company, or organization, and a transaction management system of the financial institution may also issue one or more virtual card numbers that can be used with different merchant transaction systems. For example, a first virtual credential may be usable with a first merchant only, a second virtual credential may be usable with a second merchant only, and so on. Accordingly, because virtual credentials can generally be used in the same way as an actual credit card, virtual credentials can offer increased security in online transactions that occur in a context where a physical transaction card is not required or physically presented to a merchant. For example, if a security breach were to result in a first virtual credential being exposed or otherwise compromised (e.g., to a hacker or fraudster), the virtual credential could be used only at the particular merchant and would be unusable with any other merchant(s). In this way, using the virtual credential in an online transaction may reduce a risk that, and/or an extent to which, the virtual credential can be fraudulently used, thereby improving information security. For example, a compromised virtual credential may be invalidated and a new virtual credential may be generated without affecting the primary payment credential and/or any other virtual credentials that may be linked to the primary payment credential.

As further shown in FIG. 1, and by reference number 115, the automatic payment system may receive a set of automatic payment requests from one or more creditor devices (e.g., via an application program interface (API) exposed to the one or more creditor device(s). For example, the automatic payment requests may be received prior to a scheduled date when money is to be withdrawn from or charged to the main account linked to the automatic payment requests and/or may be received on the date when money is to be withdrawn from or charged to the main account linked to the automatic payment requests. Accordingly, in some implementations, the automatic payment system may process automatic payment requests in batches (e.g., to allow for prioritizing the automatic payments when the aggregate amount would otherwise cause the balance of the main account to fail to satisfy the threshold). Additionally, or alternatively, the automatic payment system may store information that indicates when automatic payment requests are expected to be received based on a prior history of the automatic payment requests (e.g., mortgage withdrawals may be expected to occur on or within a day or two after the first of every month and/or other automatic payments may have other recurring patterns).

As further shown in FIG. 1, and by reference number 120, the automatic payment system may implement an approval decisioning based on the available balance in the linked account when a set of automatic payment requests is received and ready to be processed. For example, in some implementations, each automatic payment request may be associated with an amount to be deducted from or charged to the main account linked to the automatic payment, and the automatic payment system may be configured to determine whether an aggregate amount associated with the automatic payment requests can be deducted from or charged to the main account linked to the automatic payment without causing the available balance to fail to satisfy the applicable threshold. In cases where the aggregate amount associated with the automatic payment requests can be deducted from or charged to the linked account without causing the available balance in the linked account to fail to satisfy the applicable threshold, the automatic payment system may allow the automatic payment requests to proceed, whereby the automatic payments may each be deducted from or charged to the linked account in the manner configured by the user. Alternatively, in cases where the aggregate amount associated with the automatic payment requests can be deducted from or charged to the linked account without causing the available balance in the linked account to fail to satisfy the applicable threshold, the automatic payment system may employ further decisioning to determine which (if any) automatic payments to route to the linked account and which to delay or re-route to an alternative account to prevent the available balance in the linked account from failing to satisfy the threshold.

For example, in cases where the aggregate amount of the automatic payment requests would cause the available balance in the linked account to fail to satisfy the threshold, the automatic payment system may use machine learning techniques to determine which of the automatic payments are eligible or ineligible to re-route to an alternative account. For example, in a case where the linked account is a bank account, the alternative accounts include only credit card accounts (or VCNs linked to credit card accounts), and the automatic payment is a mortgage bill, loan installment, or other bill that must be paid via ACH transfer, the automatic payment system may determine that the automatic payment cannot be re-routed and may process the automatic payment using the linked account. However, in cases where one or more of the automatic payments are eligible to be paid via credit card, the automatic payment system may use machine learning techniques to determine relative priorities among the competing automatic payments in order to determine which to route to the linked account and which to re-route to an alternative account. For example, in some implementations, a machine learning model may be trained to determine relative priorities among different automatic payments based on features such as criticality (e.g., a utility bill, housing bill, loan installment, or similar bill may have a high criticality, whereas other services such as gym memberships or streaming services may have a low criticality), penalty avoidance (e.g., each automatic payment request may be associated with a penalty if not paid, such as potential foreclosure or eviction for an unpaid mortgage or rent payment, service shutoff for an unpaid utility bill, service suspension for an unpaid streaming service bill, or the like), interest or fees due if unpaid, when or whether the available balance in the linked account is expected to increase (e.g., based on regular payroll deposits), and/or consumption data related to the importance of the associated service to the user.

For example, in one use case, the automatic payment system may receive multiple automatic payment requests on the same day or within the same batch, and the automatic payment requests may include a credit card bill that is associated with a high interest rate and a late payment fee and a streaming service that is not associated with any late payment fees (e.g., a penalty for non-payment of the streaming service bill may be limited to service suspension, which can be reinstated by payment of the outstanding bill). In this example, the machine learning model may determine that the credit card bill has a higher priority because the credit card bill would accrue interest if not paid on time, whereas the streaming service bill (which would typically have a much smaller amount due than the credit card bill) may be re-routed to an alternative account or delayed until the available balance in the linked account has increased to a level that is sufficient to cover the billed amount without the available balance failing to satisfy the threshold. In another example, the multiple automatic payment requests may include a first credit card bill and a second credit card bill, and the automatic payment system may prioritize the competing credit card bill to minimize interest and/or fees that are due. For example, one credit card bill may be associated with a high balance but a low interest rate and the other may carry a low balance but a high interest rate. In such cases, the automatic payment system may project the interest that would be accrued in each credit card bill (e.g., on a daily or compounding basis), and may determine which credit card bill to pay from the linked account and which to delay or re-route to an alternative account to minimize penalties, interest, fees, or the like.

In other example use cases, when the multiple automatic payment requests include bills related to optional services, such as media streaming services, gym memberships, or the like, the automatic payment system may use machine learning techniques to determine the priorities among the automatic payment requests based on consumption data associated with the optional services. For example, in one use case, the automatic payment requests may include a first monthly bill for a media streaming service provided by a first service provider and a second monthly bill for a media streaming service provided by a second service provider. In this use case, the automatic payment system may gather consumption data related to each media streaming service to determine which is more important to the user at the current time. For example, in cases where the user consumes the media streaming services via the user device or another suitable device that can provide consumption data (e.g., via a browser extension), the consumption data may be provided to the automatic payment system and used to determine which media streaming service is used more frequently and/or which media streaming service appears to be more important to the user in a short-term time period (e.g., the user has been recently watching a particular series on the first service provider's media streaming service and is likely to want to finish the series, even if overall long-term consumption is higher on the second service provider's media streaming service). Additionally, or alternatively, in cases where the consumption data cannot be gathered directly, the consumption data may be gathered indirectly and/or using other suitable sources. For example, the automatic payment system may communicate with augmented reality (AR) glasses or another suitable AR device of the user, which may have a capability to observe which optional services the user is consuming using computer vision and/or provide the automatic payment system with information to derive the user's consumption patterns or consumption habits for the optional services. In another example, where the optional services include a gym membership, the automatic payment system may connect to a wearable device or activity tracker worn by the user, which may indicate how often the user exercises and/or visits the gym based on tracked location and/or movement information. In these and other use cases, the automatic payment system may determine the relative priorities of the automatic payments, which may impact whether the automatic payment system decides to route an automatic payment to the linked account, re-route the automatic payment to an alternative account, or hold the automatic payment until the available balance has increased. Furthermore, in some implementations, the automatic payment system may apply a recency bias to the consumption data to determine the relative priorities at the time that the competing automatic payment requests are due (e.g., using algorithms that can predict short-term trends in user behavior, such as a propensity to finish binge watching a series that is nearly complete).

Accordingly, as shown by reference number 120, the automatic payment system may issue, to a transaction backend system (e.g., via an API), a payment instruction associated with each automatic payment request. For example, the payment instruction may indicate that an automatic payment is to be processed using the main account linked to the automatic payment when the aggregate amount of all automatic payments can be deducted from or charged to the linked account without the available balance failing to satisfy the applicable threshold (e.g., falling below a minimum balance on a bank account or exceeding a maximum balance on a credit card account). Additionally, or alternatively, the payment instruction may indicate that an automatic payment is to be processed using the main account linked to the automatic payment in cases where the automatic payment is ineligible to be re-routed to an alternative account (e.g., where the automatic payment has be paid via ACH transfer and the linked account, but none of the alternative accounts, support ACH transfer) and/or where the automatic payment has a higher priority (e.g., based on criticality, penalty avoidance, interest, fees, consumption data, or other factors). Alternatively, the payment instruction may indicate that one or more automatic payments are to be processed using one or more of the alternative accounts designated by the user when deducting or charging the aggregate amount of all automatic payments to the linked account would cause the available balance to fail to satisfy the applicable threshold. Additionally, or alternatively, the payment instruction may indicate that one or more automatic payments are to be delayed or held until the main account linked to the automatic payment has a larger available balance (e.g., following a payroll deposit, a tax refund deposit, a scheduled credit card payment, or the like) and then deducted from or charged to the linked account. Accordingly, as shown by reference number 130, the transaction backend system may then direct each automatic payment request to the appropriate account based on the payment instruction from the automatic payment system.

As indicated above, FIG. 1 is provided as an example. Other examples may differ from what is described with regard to FIG. 1.

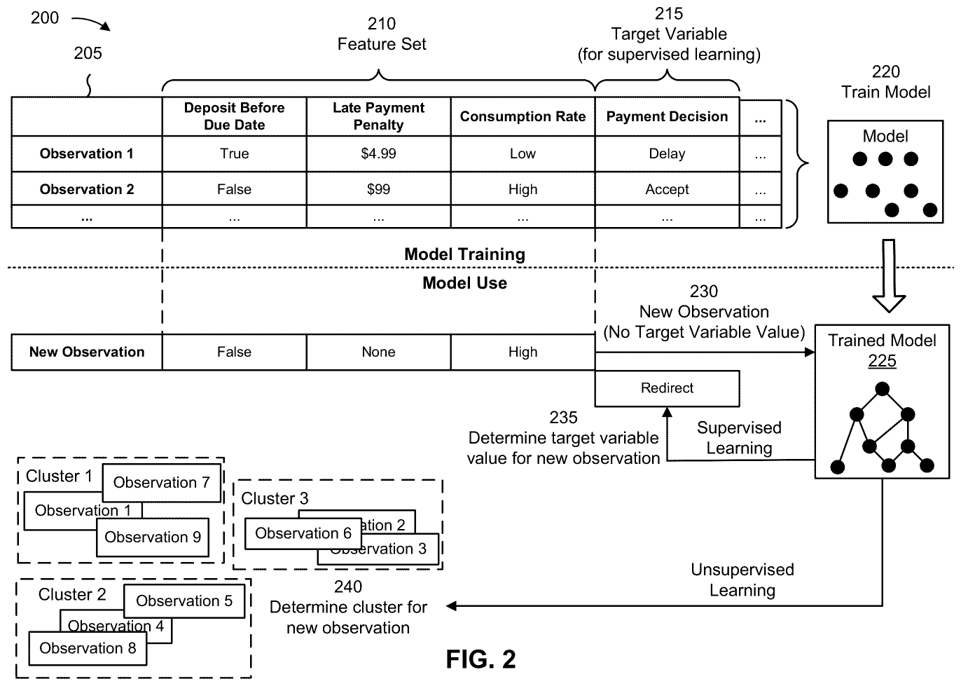

FIG. 2 is a diagram illustrating an example 200 of training and using a machine learning model in connection with intelligent decisioning and routing for requests related to automated events. The machine learning model training and usage described herein may be performed using a machine learning system. The machine learning system may include or may be included in a computing device, a server, a cloud computing environment, or the like, such as the automatic payment system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the user device, the transaction backend system, the creditor device, or another suitable device, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the user device, the transaction backend system, the creditor device, or another suitable device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of deposit before due date, a second feature of late payment penalty, a third feature of consumption rate, and so on. As shown, for a first observation, the first feature may have a value of true, the second feature may have a value of $4.99, the third feature may have a value of low, and so on. These features and feature values are provided as examples, and may differ in other examples. For example, the feature set may include one or more of the following features: criticality, interest rate, amount due, ACH required, and/or available balance in linked account, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is payment decision, which has a value of delay for the first observation (e.g., based on an expected deposit before the due date and/or a relatively low late payment penalty).

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations. For example, in some implementations, the trained machine learning model 225 may be used to determine relative priorities among different automatic payment requests when an aggregate amount associated with the automatic payment requests would cause an available balance in a linked account to fail to satisfy a threshold. Additionally, or alternatively, the trained machine learning model 225 may be used to determine whether to direct an automatic payment to the linked account, re-route the automatic payment to an alternative account, or delay the automatic payment until the available balance in the linked account has increased. Additionally, or alternatively, the trained machine learning model 225 may be used to select, among multiple alternative accounts, a suitable alternative account to which to re-route an automatic payment (e.g., re-routing an ACH-only automatic payment to an alternative bank account that supports ACH transfer rather than a credit card account).

As shown by reference number 230, the machine learning system may apply the trained machine learning model 225 to a new observation, such as by receiving a new observation and inputting the new observation to the trained machine learning model 225. As shown, the new observation may include a first feature of deposit before due date, a second feature of late payment penalty, a third feature of consumption rate, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of redirect for the target variable of payment decision for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation that a user reconfigure an automatic payment to be directed to an alternative account corresponding to a credit card account with a low balance or a low interest rate. The first automated action may include, for example, generating a payment instruction that redirects the automatic payment to the alternative account corresponding to the credit card account with the low balance or low interest rate.

As another example, if the machine learning system were to predict a value of delay for the target variable of payment decision, then the machine learning system may provide a second (e.g., different) recommendation (e.g., that the user cancel a media streaming service or other service with a low consumption rate) and/or may perform or cause performance of a second (e.g., different) automated action (e.g., generating a payment instruction that causes the automatic payment to be delayed until the available balance in the linked account has increased, such as after a payroll deposit or electronic funds transfer).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., automatic payments to be redirected to an alternative account), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to enable intelligent decisioning and routing for automatic payment requests that may cause an available balance in a linked account to fail to satisfy a threshold. The machine learning system enables recognition and/or identification of tens, hundreds, thousands, or millions of features and/or feature values for tens, hundreds, thousands, or millions of observations, thereby increasing accuracy and consistency and reducing delay associated with automatic payment decisioning, routing, re-routing, and/or delaying relative to requiring computing resources to be allocated for tens, hundreds, or thousands of operators to manually determine how to process automatic payment requests using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a transaction terminal 310, a transaction device 320, a user device 330, a transaction backend system 340, an automatic payment system 350, a creditor device 360, and/or a network 370. Devices of environment 300 may interconnect via wired connections and/or wireless connections.

The transaction terminal 310 includes one or more devices capable of facilitating an electronic transaction associated with the transaction device 320. For example, the transaction terminal 310 may include a point-of-sale (PoS) terminal, a payment terminal (e.g., a credit card terminal, a contactless payment terminal, a mobile credit card reader, or a chip reader), an automated teller machine (ATM), and/or a server device. The transaction terminal 310 may include one or more input components and/or one or more output components to facilitate obtaining data (e.g., account information) from the transaction device 320 and/or to facilitate interaction with, communication with, and/or authorization from an owner or accountholder of the transaction device 320. Example input components of the transaction terminal 310 include a number keypad, a touchscreen, a magnetic stripe reader, a chip reader, and/or a radio frequency (RF) signal reader (e.g., a near-field communication (NFC) reader). Example output devices of transaction terminal 310 include a display and/or a speaker.

The transaction device 320 includes one or more devices capable of being used for an electronic transaction. In some implementations, the transaction device 320 includes a transaction card (or another physical medium with integrated circuitry) capable of storing and communicating account information, such as a credit card, a debit card, a gift card, an ATM card, a transit card, a fare card, and/or an access card. In some implementations, the transaction device 320 may be the user device 330 or may be integrated into the user device 330. For example, the user device 330 may execute an electronic payment application capable of performing functions of the transaction device 320 described herein. Thus, one or more operations described herein as being performed by the transaction device 320 may be performed by a transaction card, the user device 330, or a combination thereof.

The transaction device 320 may store account information associated with the transaction device 320, which may be used in connection with an electronic transaction facilitated by the transaction terminal 310. The account information may include, for example, an account identifier that identifies an account (e.g., a bank account or a credit account) associated with the transaction device 320 (e.g., an account number, a card number, a bank routing number, and/or a bank identifier), a cardholder identifier (e.g., identifying a name of a person, business, or entity associated with the account or the transaction device 320), expiration information (e.g., identifying an expiration month and/or an expiration year associated with the transaction device 320), and/or a credential (e.g., a payment token). In some implementations, the transaction device 320 may store the account information in tamper-resistant memory of the transaction device 320, such as in a secure element. As part of performing an electronic transaction, the transaction device 320 may transmit the account information to the transaction terminal 310 using a communication component, such as a magnetic stripe, an integrated circuit (IC) chip (e.g., a EUROPAY®, MASTERCARD®, VISA® (EMV) chip), and/or a contactless communication component (e.g., an NFC component, an RF component, a Bluetooth component, and/or a Bluetooth Low Energy (BLE) component). Thus, the transaction device 320 and the transaction terminal 310 may communicate with one another by coming into contact with one another (e.g., using a magnetic stripe or an EMV chip) or via contactless communication (e.g., using NFC).

The user device 330 includes one or more devices capable of being used for an electronic transaction, as described above in connection with the transaction device 320. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, a virtual reality headset, or an augmented reality device), or a similar type of device. Additionally, or alternatively, the user device 330 may be capable of receiving, generating, storing, processing, and/or providing information associated with intelligent decisioning and routing for requests related to automated events. For example, as described elsewhere herein, the user device 330 may be used to communicate with the transaction terminal 310 to authorize an automatic payment using a main account (e.g., a bank account or a credit card account) and/or may be used to communicate with the automatic payment system 350 to enable the automatic payment to be routed to an alternative account other than the main account.

The transaction backend system 340 includes one or more devices capable of processing, authorizing, and/or facilitating a transaction. For example, the transaction backend system 340 may include one or more servers and/or computing hardware (e.g., in a cloud computing environment or separate from a cloud computing environment) configured to receive and/or store information associated with processing an electronic transaction. The transaction backend system 340 may process a transaction, such as to approve (e.g., permit, authorize, or the like) or decline (e.g., reject, deny, or the like) the transaction and/or to complete the transaction if the transaction is approved. The transaction backend system 340 may process the transaction based on information received from the transaction terminal 310, such as transaction data (e.g., information that identifies a transaction amount, a merchant, a time of a transaction, a location of the transaction, or the like), account information communicated to the transaction terminal 310 by the transaction device 320, and/or information stored by the transaction backend system 340 (e.g., for fraud detection).

The transaction backend system 340 may be associated with a financial institution (e.g., a bank, a lender, a credit card company, or a credit union) and/or may be associated with a transaction card association that authorizes a transaction and/or facilitates a transfer of funds. For example, the transaction backend system 340 may be associated with an issuing bank associated with the transaction device 320, an acquiring bank (or merchant bank) associated with the merchant and/or the transaction terminal 310, and/or a transaction card association (e.g., VISA® or MASTERCARD®) associated with the transaction device 320. Based on receiving information associated with the transaction device 320 from the transaction terminal 310 and/or the automatic payment system 350, one or more devices of the transaction backend system 340 may communicate to authorize a transaction and/or to transfer funds from an account associated with the transaction device 320 or from an alternative account to an account of an entity (e.g., a merchant) associated with the transaction terminal 310.

The automatic payment system 350 includes one or more devices capable of receiving, generating, storing, processing, providing, and/or routing information associated with intelligent decisioning and routing for requests related to automated events, as described elsewhere herein. The automatic payment system 350 may include a communication device and/or a computing device. For example, the automatic payment system 350 may include a server, such as an application server, a client server, a web server, a database server, a host server, a proxy server, a virtual server (e.g., executing on computing hardware), or a server in a cloud computing system. In some implementations, the automatic payment system 350 includes computing hardware used in a cloud computing environment.

The creditor device 360 includes one or more devices capable of receiving, generating, storing, processing, providing, and/or routing information associated with intelligent decisioning and routing for requests related to automated events, as described elsewhere herein. The creditor device 360 may include a communication device and/or a computing device. For example, the creditor device 360 may include a server, such as an application server, a client server, a web server, a database server, a host server, a proxy server, a virtual server (e.g., executing on computing hardware), or a server in a cloud computing system. In some implementations, the creditor device 360 includes computing hardware used in a cloud computing environment.

The network 370 includes one or more wired and/or wireless networks. For example, the network 370 may include a cellular network, a public land mobile network, a local area network, a wide area network, a metropolitan area network, a telephone network, a private network, the Internet, and/or a combination of these or other types of networks. The network 370 enables communication among the devices of environment 300. In some implementations, the transaction terminal 310 may communicate with the transaction device 320 using a first network (e.g., a contactless network or by coming into contact with the transaction device 320) and may communicate with the transaction backend system 340 using a second network.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with intelligent decisioning and routing for requests related to automated events. Device 400 may correspond to the transaction terminal 310, the transaction device 320, the user device 330, the transaction backend system 340, the automatic payment system 350, and/or the creditor device 360. In some implementations, the transaction terminal 310, the transaction device 320, the user device 330, the transaction backend system 340, the automatic payment system 350, and/or the creditor device 360 may include one or more devices 400 and/or one or more components of device 400. As shown in FIG. 4, device 400 may include a bus 410, a processor 420, a memory 430, an input component 440, an output component 450, and a communication component 460.

Bus 410 may include one or more components that enable wired and/or wireless communication among the components of device 400. Bus 410 may couple together two or more components of FIG. 4, such as via operative coupling, communicative coupling, electronic coupling, and/or electric coupling. Processor 420 may include a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 may include one or more processors capable of being programmed to perform one or more operations or processes described elsewhere herein.

Memory 430 may include volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 may include one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

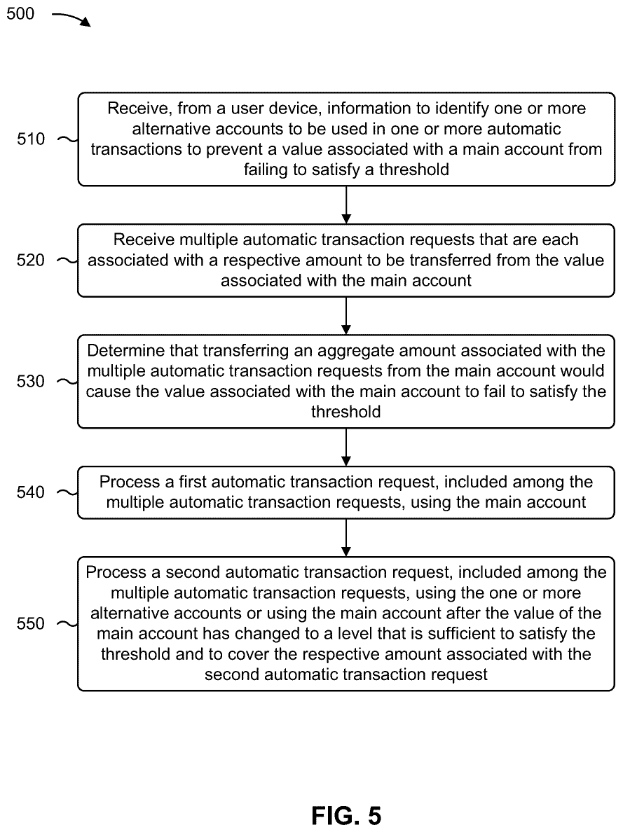

FIG. 5 is a flowchart of an example process 500 associated with intelligent decisioning and routing for requests related to automated events. In some implementations, one or more process blocks of FIG. 5 may be performed by the automatic payment system 350. In some implementations, one or more process blocks of FIG. 5 may be performed by another device or a group of devices separate from or including the automatic payment system 350, such as the transaction terminal 310, the transaction device 320, the user device 330, the transaction backend system 340, and/or the creditor device 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a user device, information to identify one or more alternative accounts to be used in one or more automatic transactions to prevent a value associated with a main account from failing to satisfy a threshold (block 510). For example, the automatic payment system 350 (e.g., using processor 420, memory 430, input component 440, and/or communication component 460) may receive, from a user device, information to identify one or more alternative accounts to be used in one or more automatic transactions to prevent a value associated with a main account from failing to satisfy a threshold, as described above in connection with reference number 110 of FIG. 1. As an example, a user of the user device may hold one or more accounts (e.g., debit or savings accounts, credit card accounts, or the like) that are linked to automatic payments such as mortgage payments, automobile loan or lease payments, utility bills, streaming services, and/or gym memberships, among other examples. Accordingly, as described elsewhere herein, the user of the user device may interact with the automatic payment system to indicate one or more alternative accounts (e.g., other bank accounts, other credit card accounts, VCNs linked to a credit card account, or the like) that an automatic payment request should be routed to in a scenario where processing the automatic payment using the linked account would cause a value or balance of the linked account to fail to satisfy a threshold (e.g., causing a debit or savings account to fall below zero or other threshold, causing a credit balance to exceed a credit limit or other threshold, or the like).

As further shown in FIG. 5, process 500 may include receiving multiple automatic transaction requests that are each associated with a respective amount to be transferred from the value associated with the main account (block 520). For example, the automatic payment system 350 (e.g., using processor 420, memory 430, input component 440, and/or communication component 460) may receive multiple automatic transaction requests that are each associated with a respective amount to be transferred from the value associated with the main account, as described above in connection with reference number 115 of FIG. 1. As an example, the automatic payment system may receive a first automatic transaction request for a mortgage associated with a regular monthly payment deducted from a bank account, a second automatic transaction request for a utility bill associated with a budgeted amount or a usage-based amount deducted from the bank account, and a third automatic transaction request for a streaming service associated with a monthly fee deducted from the bank account.

As further shown in FIG. 5, process 500 may include determining that transferring an aggregate amount associated with the multiple automatic transaction requests from the main account would cause the value associated with the main account to fail to satisfy the threshold (block 530). For example, the automatic payment system 350 (e.g., using processor 420 and/or memory 430) may determine that transferring an aggregate amount associated with the multiple automatic transaction requests from the main account would cause the value associated with the main account to fail to satisfy the threshold, as described above in connection with reference number 120 of FIG. 1. As an example, the main account may be a bank account such as a debit, checking, or savings account, and the regular monthly mortgage payment, the utility bill, and the monthly fee of the streaming service may have an aggregate amount that would cause an overdraft against a bank account, cause a balance of a bank account to fall below a threshold, cause an outstanding balance on a credit card to exceed a credit limit or another threshold (e.g., a user-specified spending limit) if the regular monthly mortgage payment, the utility bill, and the monthly fee of the streaming service were to be paid from or otherwise processed using the bank account.

As further shown in FIG. 5, process 500 may include processing a first automatic transaction request, included among the multiple automatic transaction requests, using the main account (block 540). For example, the automatic payment system 350 (e.g., using processor 420 and/or memory 430) may process a first automatic transaction request, included among the multiple automatic transaction requests, using the main account, as described above in connection with reference numbers 125 and 130 of FIG. 1. As an example, the automatic payment system may determine that the monthly mortgage bill is ineligible to be routed to an alternative account such as a credit card account and has to be paid from a bank account such as a debit, checking, or savings account, and that the utility bill and streaming service bill are eligible to be routed to an alternative account or delayed until there are more funds available in the bank account (e.g., after a pending, scheduled, or expected deposit to the bank account, such as a regular payroll deposit). In this example, the automatic payment system may generate a payment instruction (e.g., to a transaction backend system) directing that the monthly mortgage bill be paid from the main account.

As further shown in FIG. 5, process 500 may include processing a second automatic transaction request, included among the multiple automatic transaction requests, using the one or more alternative accounts or using the main account after the value of the main account has changed to a level that is sufficient to satisfy the threshold and to cover the respective amount associated with the second automatic transaction request (block 550). For example, the automatic payment system 350 (e.g., using processor 420 and/or memory 430) may process a second automatic transaction request, included among the multiple automatic transaction requests, using the one or more alternative accounts or using the main account after the value of the main account has changed to a level that is sufficient to satisfy the threshold and to cover the respective amount associated with the second automatic transaction request, as described above in connection with reference numbers 125 and 130 of FIG. 1. As an example, the automatic payment system may determine that one or more automatic transaction requests in a batch of pending automatic payments are eligible to be routed to an alternative account or delayed until the available balance of a main account has increased (e.g., after a deposit to increase the balance of a bank account or a payment to increase the available credit in a credit card account). For example, in the scenario described herein where the utility bill and the streaming service bill are eligible to route to an alternative account or delayed until the available balance in a bank account has increased, the automatic payment system may generate a payment instruction (e.g., to a transaction backend system) directing that the utility bill and the streaming bill are to be routed to an alternative account such as a credit card or VCN or delayed until the bank account has increased to a sufficient level that deducting the associated amount(s) would not cause the balance of the bank account to drop below zero or another suitable threshold.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIG. 1. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for intelligent decisioning and routing for automatic transaction requests, the system comprising:
one or more memories; and
one or more processors, communicatively coupled to the one or more memories, configured to:
receive, from a user device, information to identify one or more alternative accounts to be used in one or more automatic transactions to prevent a value associated with a main account from failing to satisfy a threshold;
receive multiple automatic transaction requests that are each associated with a respective amount to be transferred from the value associated with the main account;
determine that transferring an aggregate amount associated with the multiple automatic transaction requests from the main account would cause the value associated with the main account to fail to satisfy the threshold;
process a first automatic transaction request, included among the multiple automatic transaction requests, using the main account; and
process a second automatic transaction request, included among the multiple automatic transaction requests, using the one or more alternative accounts or using the main account after the value of the main account has changed to a level that is sufficient to satisfy the threshold and to cover the respective amount associated with the second automatic transaction request.

2. The system of claim 1, wherein the one or more processors are further configured to:
identify the first automatic transaction request and the second automatic transaction request using a machine learning model that is trained to assign relative priorities to the multiple automatic transaction requests.

3. The system of claim 2, wherein the first automatic transaction request is processed using the main account based on the machine learning model assigning a first priority to the first automatic transaction request that is higher than a second priority assigned to the second automatic transaction request.

4. The system of claim 2, wherein the machine learning model is trained to assign the relative priorities to the multiple automatic transaction requests based on one or more features that relate to criticality, penalty avoidance, interest avoidance, or an impending change to the value of the main account.

5. The system of claim 2, wherein the machine learning model is trained to assign the relative priorities to the multiple automatic transaction requests based on consumption data for respective services associated with the multiple automatic transaction requests.

6. The system of claim 5, wherein the machine learning model is trained to apply a recency bias to the consumption data for the respective services associated with the multiple automatic transaction requests.

7. The system of claim 1, wherein the first automatic transaction request is processed using the main account based on the first automatic transaction request having a type that is ineligible to delay or redirect to the one or more alternative accounts.

8. A method for intelligent processing of automatic transaction requests, comprising:
receiving, by a system, an automatic transaction request associated with an amount to be transferred from a value associated with a main account;
determining, by the system, that transferring the amount associated with the automatic transaction request from the main account would cause the value associated with the main account to fail to satisfy a threshold;
generating, by the system, an alternative transaction processing instruction to prevent the automatic transaction request from causing the value associated with the main account to fail to satisfy the threshold; and
processing, by the system, the automatic transaction request according to the alternative transaction processing instruction, wherein processing the automatic transaction request includes:
processing the automatic transaction request using one or more alternative accounts, or
processing the automatic transaction request using the main account after the value of the main account has changed to a level that is sufficient to satisfy the threshold and to cover the amount associated with the automatic transaction request.

9. The method of claim 8, further comprising:
receiving, from a user device, information to identify the one or more alternative accounts to be used to prevent the value associated with the main account from failing to satisfy the threshold.

10. The method of claim 8, wherein the transaction processing instruction is generated based on a priority associated with the automatic transaction request.

11. The method of claim 10, wherein the automatic transaction request is processed according to the alternative transaction processing instruction based on the priority associated with the automatic transaction request being lower than a priority associated with another automatic transaction request.

12. The method of claim 10, wherein the priority associated with the automatic transaction request is based on a criticality of the automatic transaction request, avoidance of a penalty associated with non-payment or delayed payment of the automatic transaction request, avoidance of interest incurred by non-payment or delayed payment of the automatic transaction request, an impending change to the value of the main account, or consumption data associated for a service associated with the automatic transaction request.

13. The method of claim 8, wherein the automatic transaction request is processed according to the alternative transaction processing instruction based on the automatic transaction request having a type that is eligible to delay or redirect to the one or more alternative accounts.

14. A non-transitory computer-readable medium storing a set of instructions, the set of instructions comprising:
one or more instructions that, when executed by one or more processors of a system, cause the system to:
receive multiple automatic transaction requests that are each associated with a respective amount to be transferred from a value associated with a main account;
determine that transferring an aggregate amount associated with the multiple automatic transaction requests from the main account would cause the value associated with the main account to fail to satisfy a threshold;
generate a first instruction to process a first set of automatic transaction requests, included among the multiple automatic transaction requests, using the main account;
generate a second instruction to process a second set of automatic transaction requests, included among the multiple automatic transaction requests, using one or more alternative accounts; and
generate a third instruction to delay processing a third set of automatic transaction requests, included among the multiple automatic transaction requests, until the value of the main account has changed to a level that is sufficient to satisfy the threshold and to cover the respective amounts associated with the third set of automatic transaction requests.

15. The non-transitory computer-readable medium of claim 14, wherein the one or more instructions further cause the system to:
identify the first set of automatic transaction requests, the second set of automatic transaction requests, and the third set of automatic transaction requests using a machine learning model that is trained to assign relative priorities to the multiple automatic transaction requests.

16. The non-transitory computer-readable medium of claim 15, wherein the first set of automatic transaction requests are processed using the main account based on the machine learning model assigning a priority to the first set of automatic transaction requests that is higher than priorities assigned to the second set of automatic transaction requests and the third set of automatic transaction requests.

17. The non-transitory computer-readable medium of claim 15, wherein the machine learning model is trained to assign the relative priorities to the multiple automatic transaction requests based on one or more features that relate to criticality, penalty avoidance, interest avoidance, or an impending change to the value of the main account.

18. The non-transitory computer-readable medium of claim 15, wherein the machine learning model is trained to assign the relative priorities to the multiple automatic transaction requests based on consumption data for respective services associated with the multiple automatic transaction requests.

19. The non-transitory computer-readable medium of claim 18, wherein the machine learning model is trained to apply a recency bias to the consumption data for the respective services associated with the multiple automatic transaction requests.

20. The non-transitory computer-readable medium of claim 14, wherein the first set of automatic transaction requests include one or more automatic transaction requests that are ineligible to be delayed or redirected to the one or more alternative accounts.
